(19) United States
(12) Patent Application Publication
(10) Pub. No.: US 2010/0017311 A1
(43) Pub. Date: Jan. 21, 2010

(54) ASSET RECOVERY SYSTEM AND METHOD

(76) Inventor: Brian Gallagher, Chicago, IL (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(21) Appl. No.: 12/504,384

(22) Filed: Jul. 16, 2009

Related U.S. Application Data
(60) Provisional application No. 61/081,255, filed on Jul. 16, 2008.

(51) Int. Cl. G06Q 10/00; G06Q 90/00; G06F 15/16

(52) U.S. Cl. 705/28; 705/30; 705/500; 709/206

(57) ABSTRACT

An asset recovery system and method is provided for recovering value from shipped products that are returned and/or rejected by the purchaser or recipient. The system and method include inspecting the rejected or returned product at a returns center, assessing the cost to repair or refurbish the product. If the assessment is within a predetermined cost structure the product is repaired or refurbished and placed in a saleable item inventory for resale to a customer. If the assessment is outside the predetermined cost structure, the product is liquidated.

### CROSS-REFERENCE TO RELATED APPLICATIONS

The present invention claims the benefit of U.S. Provisional Patent Application No. 61/081,255 filed Jul. 16, 2008, the contents of which are incorporated herein by reference.

### FEDERALLY SPONSORED RESEARCH OR DEVELOPMENT

N/A

### FIELD OF THE INVENTION

The present invention relates to a system and method for recovering value from returned and/or rejected products that had been, or are in the process of being, shipped to a purchaser.

### DESCRIPTION OF THE PRIOR ART

Products that are shipped to a purchaser or other recipient are sometimes returned and/or rejected (either at delivery or prior to delivery) by the recipient for a number of reasons. In the past, such products were typically returned to the manufacturer, disposed of or otherwise given away, or sent to a liquidator. Most, if not all of the value in the product was therefore lost. Moreover, attempts to repair or refurbish the product have cost more (taking into consideration transportation and other related costs) than the products “new” value.

The present invention is provided to solve the problems discussed above and other problems, and to provide advantages and features not provided by prior systems or methods for handling returned products. A full discussion of the features and advantages of the present invention is deferred to the following detailed description, which proceeds with reference to the accompanying drawings.

### SUMMARY OF THE INVENTION

The present invention provides a system and method for recovering additional value from returned or rejected products.

In accordance with one embodiment of the invention, a method for recovering value from a returned product originally shipped to a recipient is provided. The method comprises receiving an electronic communication over a network requesting a product be returned from a recipient or purchaser (i.e., customer) of the product. This can be, for example, an e-mail received from the customer. The method further includes delivering the product to a returns center (in some cases, this includes picking the product up from the customer), inspecting the condition of the product at the returns center and assessing whether the product can be repaired or refurbished within a predetermined cost structure. A report can be generated from the inspection and/or assessment. Based on the assessment, the method includes repairing or refurbishing the product if the assessment is within the predetermined cost structure.

The method can further include placing the product into a saleable inventory after it has been repaired or refurbished. Alternatively, the method can include liquidating the product if the assessment is outside of the predetermined cost structure. The cost structure can be expressed in monetary terms, or as an amount of time required to repair or refurbish the product.

If the product is repaired or refurbished, it is placed in a warehouse and added to the saleable items inventory. The method can then include processing a new order for the repaired or refurbished product from a new customer (or the old customer), and shipping the repaired or refurbished product to the new customer.

In accordance with another aspect of the invention, a method for recovering value from a returned or rejection product is provided. The method comprises the steps of determining if a product is refused prior to delivery, refused at delivery, or being returned after delivery by a customer. Upon this determination the method includes moving the product to a returns center, assessing the condition of the product and, determining if greater value can be derived from reconditioning the product for resale or liquidating the product. The method can include picking up the product from the customer if the product is being returned after delivery.

The step of assessing the condition of the product includes determining the estimated value of the product after repairing or refurbishing the product. Additionally, this step can include determining its current value without repairing or refurbishing the product.

Based on the assessment, the method includes repairing or refurbishing the product if it is determined greater value can be derived from reconditioning the product, and adding the product to a saleable inventory. Alternatively, the method includes liquidating the product if it is determined greater value can be derived from liquidating the product.

In accordance with yet another embodiment of the invention, an asset recovery system for recovering value from shipped or rejected products is provided. The system comprises a server coupled to a network to receive a product rejection or return request from a customer, and a delivery system for transporting the rejected or returned product to a product returns center. The product returns center is set up to assess the condition of the product to determine if reconditioning the product would be within a predetermined cost structure, and to generate an electronic report of the assessment.

The system can include a saleable inventory list maintained on the server. The product can be added to the list upon reconditioning.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings and attachments in which:

FIG. 1 is a flow chart of the present system and method for recovering value from a returned or rejected shipped product by the recipient;

FIG. 2 is a flow chart of the returns center receipt and inspection flow system and method in accordance with the present invention; and,

FIG. 3 is a flow chart of the returns center liquidation and reconciliation flow system and method in accordance with the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

Aspects of the disclosed system and process are implemented on computers and/or hand held devices capable of communication over a network, such as the Internet, and can utilize websites, e-mail and other known Internet or network related functionality. The network can be wireless or via cables or other known connection mechanisms.

The present invention is directed to a product returns system and/or process that provides consistency and controls to the system. The system is preferably implemented with respect to goods or other products that are shipped to a purchaser or other recipient in connection with an Internet or telephone purchase. However, the system may also have application for goods purchased at a store and then were transported to the recipient's home by the purchaser.

The system and method is preferably implemented by or in connection with a transportation company used to ship and recover rejected or returned products.

The process is initiated with a customer notification, typically sent as an e-mail requesting instructions for disposition of an unwanted or defective product. In this regard, the “customer” can be a supplier of the products at issue enrolled in a returns program sponsored by the transportation company. Alternatively, the “customer” can be the purchaser of the rejected or returned product.

The system replies to the customer e-mail with an e-mail requesting disposition instructions. The system e-mail can include a form (or a link to a website where the form can be found) that obtains information from the customer regarding the disposition. Such information can include whether the customer intends to file a claim, authorization to dispose of the product, an address to deliver/reconsign the product, and approval for the product to be transferred to a returns center for further processing. A time limit for a response (e.g., five days) can be imposed. If a response is not provided, the system can automatically implement certain return procedures.

The product is picked up from the recipient and is transported to a returns management system or center which provides an asset recovery solution for handling the returned product (or if not yet delivered, is diverted to the returns management system or center). The solution includes inspection and assessment of the product to determine if the product should be restored, reconsigned or liquidated.

An assessment includes: determining if the product will be able to be returned to “Like New” status; determining if the return of the product to “Like New” status can be done within a predetermined cost structure (this can be expressed as to whether it will take greater than a predetermined time period to make the repair); determining if the product can only be brought to a “Bumped and Bruised” condition; and determining that the product can not be brought to a “Bumped and Bruised” condition.

If the product is to be repaired (or refurbished), a set amount of time is established to complete this. If more time is necessary, approval is required to proceed.

If the product is either brought to “Like New” or “Bumped or Bruised” status, it is then repackaged and prepared for shipping or warehousing. The repackaged product can be placed into inventory for quick-ship, low cost transportation. If the product cannot be suitably repaired (or refurbished) it can be liquidated.

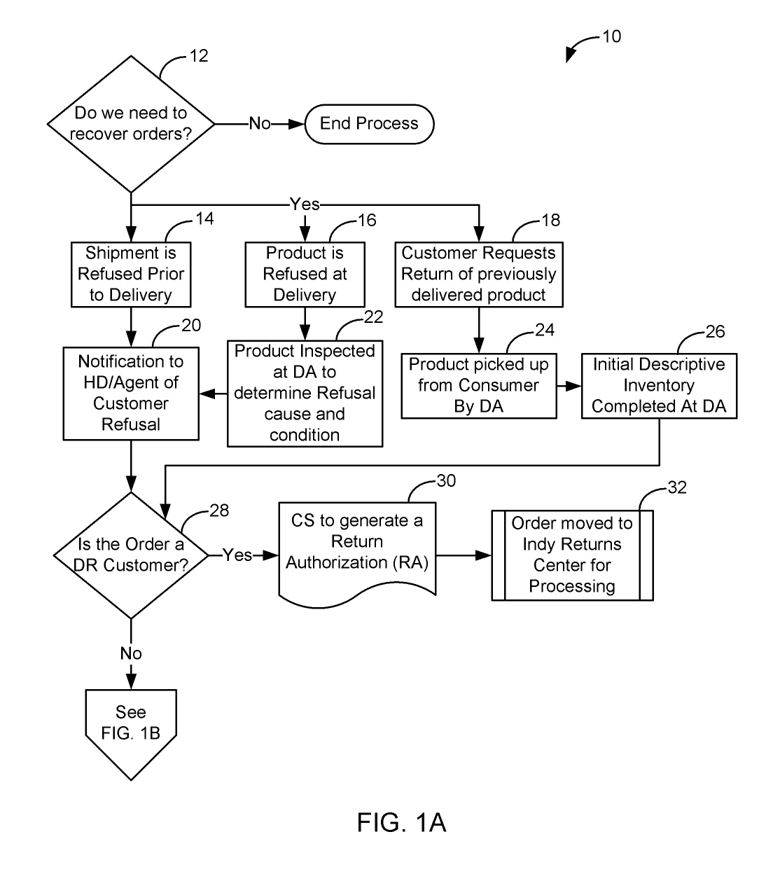

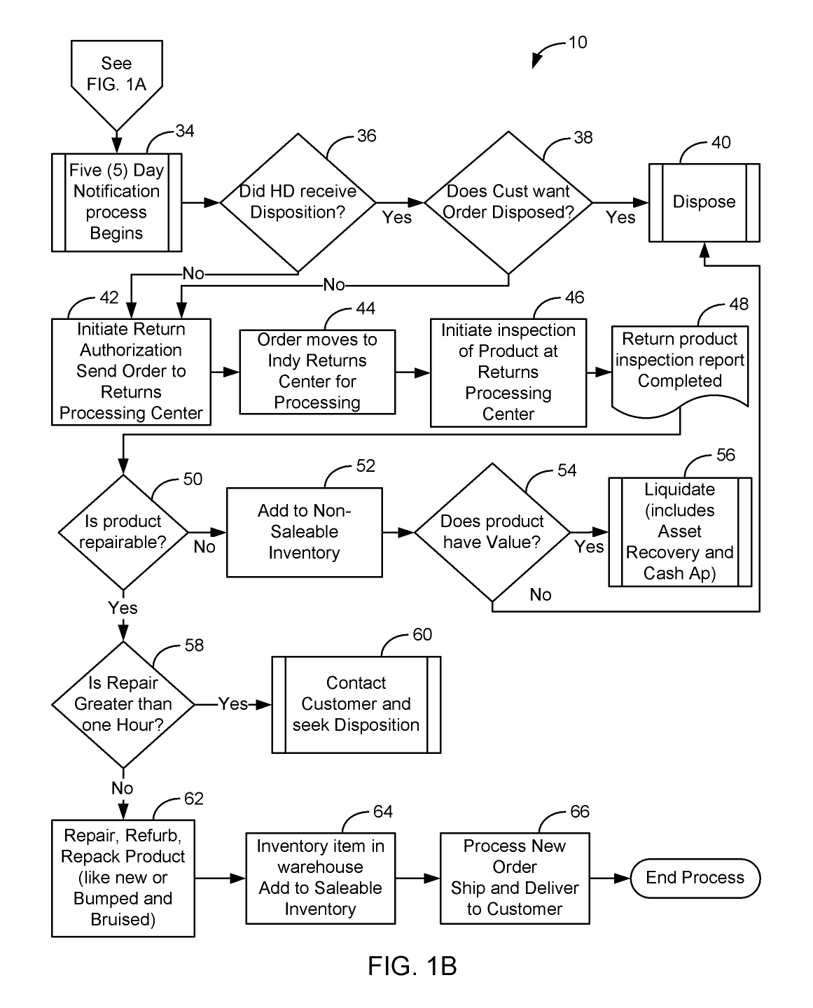

Referring to the flow chart of FIG. 1, the process 10 is initiated upon a notification that an order for a product needs to be recovered 12. This notification may be received via an e-mail or other similar electronic communication at a server maintained by the entity running the process.

Preferably the notification indicates one of whether the product shipment is refused prior to delivery 14, at delivery 16, or is being returned sometime after delivery was made 18. If the refusal is prior to delivery 14, notification is sent to an Agent of the customer refusal 20. If the refusal is made at delivery 16, the product is inspected to determine the cause of refusal and the condition of the product 22. Notification is then sent to the Agent of the customer refusal 20.

When a customer requests return of the product after delivery 18, the product is picked up from the customer 24. An initial descriptive inventory is then completed by the delivery agent picking up the product 26.

In either event, the process then involves determining if the product order was from a customer in a “direct recovery” program 28. If the customer is in the direct recovery program, a return authorization form is generated 30, and the product is shipped to a returns center for further processing 32. Otherwise, a notification process is initiated (typically for a predetermined number of days, e.g., five days) 34. The process determines if information regarding disposition of the product has been received 36, and inquires as to whether the customer wants the order disposed 38. If the customer responds in the affirmative, the product is disposed 40. If the customer does not want to dispose of the product, authorization is provided to send the product to the returns center (sometimes referred to as the “returns processing center”) 42. The product is then moved to the returns center 44.

At the returns center, the product is inspected 46, and an inspection report is prepared 48. During inspection, a determination is made as to whether the product can be reconditioned for sale 50, that is, can it be repaired or refurbished to a saleable status.

If it can't be reconditioned, the product is added to a non-saleable inventory 52. In this event, a determination is then made as to whether the product has any liquidation value 54. If the product has liquidation value it is liquidated 56. If not, the product is disposed 40.

If the product can be repaired or refurbished, a determination is made as to whether such repair or refurbishment is within a predetermined cost structure 58. The cost structure can be expressed, for example, as a dollar amount, or as an amount of time necessary to implement the repair or refurbishment. If it is determined the cost exceeds the predetermined cost structure, the customer can be contacted again regarding disposition 60.

If the cost does not exceed the predetermined cost structure, the product is repaired or refurbished and packaged for resale 62. The product can be labeled “like new” or “bumped and bruised” depending on its repaired or refurbished condition.

The product is then repackaged and placed in a warehouse and added to the saleable inventory 64. The product can then be purchased and delivered to the prior customer or a new customer 66.

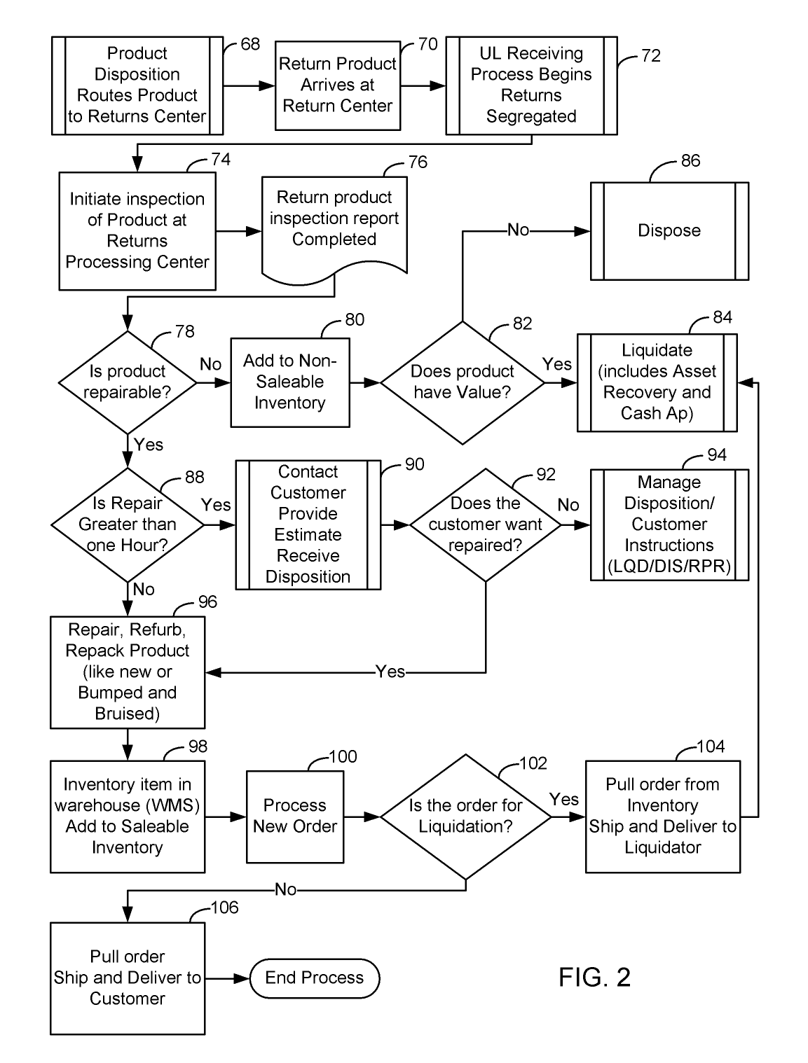

The flow chart of FIG. 2 focuses on the process at the returns center. The product is routed to the returns center 68. Upon arrival 70, the product is segregated 72 and inspected 74. An inspection report is then prepared and completed 76.

As discussed, a determination is made as to whether the product can be reconditioned for sale 78, that is, can it be repaired or refurbished to a saleable status.

If it can't be reconditioned, the product is added to a non-saleable inventory 80. In this event, a determination is then made as to whether the product has any liquidation value 82. If the product has liquidation value it is liquidated 84. If not, the product is disposed 86.

If the product can be repaired or refurbished, a determination is made as to whether such repair or refurbishment is within a predetermined cost structure 88. If it is determined the cost exceeds the predetermined cost structure, the customer can be contacted again regarding disposition 90. This includes providing an estimate for the repair or refurbishment. The customer is then asked if he or she wants the product repaired 92. If not, the product is disposed per the customer's directions 94.

If the customer indicates he or she wants the product repaired or refurbished 92, or such repair or refurbishment falls within the predetermined cost structure 88, the product is repaired or refurbished at the returns center 96. The product is then placed in a warehouse and added to the saleable inventory 98.

A new order is then processed 100. A determination is made as to whether the order is for liquidation 102. If so, the order is pulled from inventory and shipped to a liquidator 104. If not, it is delivered to the customer 106.

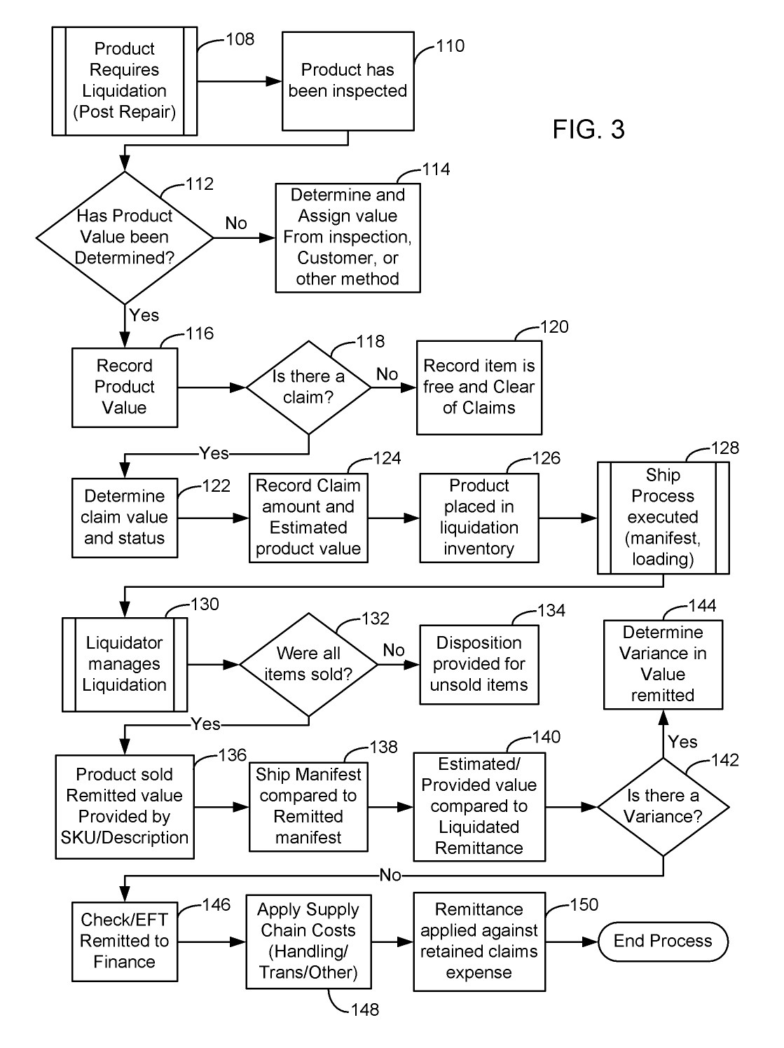

FIG. 3 shows a process for liquidating the product after it has been repaired or refurbished. In this instance, a determination has been made the product is to be liquidated 108, and that it has been inspected 110. A determination is then made as to whether the product's value has been determined 112. If not already done, the product's value is determined 114.

If the value has been determined, it is recorded 116. Following the recording of value, a determination is made as to whether there are any claims against the product 118. If none, a record that the product is free or clear of claims is made 120.

If a claim exists, a determination is made of the claims value and status 122. A record is then made of the claim amount and the estimated value of the product 124, and the product is placed in the liquidation inventory 126 and shipped to the liquidator 128 who manages the liquidation 130.

A determination is made as to whether all products were sold 132. If not, a disposition is provided for the unsold items 134. If all the products were sold, the remitted value is provided 136 and a ship manifest is compared to a remitted manifest 138. The estimated value is then compared to the liquidated remittance 140. A determination is then made as to whether there is a variance between these values 142.

If there is a variance, a determination is made of the variance in value remitted 144. If not, a check is remitted to the finance department 146. Supply chain costs (e.g., handling, transportation, etc.) are then applied 148, and remittance is applied against the retained claims expense 150.

The present system and method provides improvement of inventory controls, visibility and costs. The centralized returns center allows for optimizing the value of returned products by reducing shipping and other expenses.

Many modifications and variations of the present invention are possible in light of the above teachings. It is, therefore, to be understood within the scope of the appended claims the invention may be protected otherwise than as specifically described.

I claim:

1. A method for recovering value from a returned product originally shipped to a recipient comprising the steps of:
receiving an electronic communication over a network requesting a product be returned from a recipient of the product;
delivering the product to returns center;
inspecting the condition of the product at the returns center;
assessing whether the product can be repaired or refurbished within a predetermined cost structure; and,
repairing or refurbishing the product if the assessment is within the predetermined cost structure.

2. The method of claim 1 further comprising the step of:
placing the product into a saleable inventory after it has been repaired or refurbished.

3. The method of claim 1 further comprising the step of:
liquidating the product if the assessment is outside of the predetermined cost structure.

4. The method of claim 1 wherein the step of receiving an electronic communication over a network requesting a product be returned from a recipient of the product includes receiving an e-mail from the recipient over the Internet.

5. The method of claim 1 wherein the predetermined cost structure corresponds to an assessed predetermined time for repairing or refurbishing the product.

6. The method of claim 2 further comprising the step of:
placing the product in a warehouse.

7. The method of claim 6 further comprising the step of:
processing a new order for the repaired or refurbished product from a new customer; and,
shipping the repaired or refurbished product to the new customer.

8. The method of claim 1 wherein the step of inspecting the condition of the product at the returns center includes assigning a monetary value to the product.

9. The method of claim 1 wherein the step of inspecting the condition of the product at the returns center includes creating an inspection report

10. A method for recovering value from a returned or rejection product comprising the steps of:
determining if a product is one of refused prior to delivery, refused at delivery, and being returned after delivery by a customer;
moving the product to a returns center;
assessing the condition of the product; and,
determining if greater value can be derived from reconditioning the product for resale or liquidating the product.

11. The method of claim 1 further comprising the step of:
picking up the product from the customer if the product is being returned after delivery.

12. The method of claim 10 wherein the step of assessing the condition of the product includes determining if repairing or refurbishing the product will be within a predetermined cost structure.

13. The method of claim 12 wherein the step of assessing the condition of the product includes determining the estimated value of the product after repairing or refurbishing the product.

14. The method of claim 10 wherein the step of assessing the condition of the product includes determining its current value without repairing or refurbishing the product.

15. The method of claim 12 wherein the predetermined cost structure is represented by an estimated time it would take to repair or refurbish the product.

16. The method of claim 10 further comprising the step of:
repairing or refurbishing the product if it is determined greater value can be derived from reconditioning the product.

17. The method of claim 16 further comprising the step of:
adding the product to a saleable inventory.

18. The method of claim 10 further comprising the step of:
liquidating the product if it is determined greater value can be derived from liquidating the product.

19. An asset recovery system for recovering value from shipped or rejected products comprising:
a server coupled to a network to receive a product rejection or return request from a customer;
a delivery system for transporting the rejected or returned product to a product returns center, the product returns center set up to assess the condition of the product to determine if reconditioning the product would be within a predetermined cost structure, and to generate an electronic report of the assessment.

20. The system of claim 19 further comprising a saleable inventory list maintained on the server, wherein the product is added to the list upon reconditioning.
